(19) United States
(12) Patent Application Publication
(10) Pub. No.: US 2017/0003748 A1
(43) Pub. Date: Jan. 5, 2017

(54) METHOD AND APPARATUS FOR AUTOMATICALLY OPERATING A GESTURE CONTROL SYSTEM FOR A PROJECTION SYSTEM

(71) Applicant: Motorola Mobility LLC, Chicago, IL (US)

(72) Inventors: Jiri Slaby, Buffalo Grove, IL (US); Rachid M. Alameh, Crystal Lake, IL (US); William R. Groves, Naperville, IL (US)

(21) Appl. No.: 14/827,689

(22) Filed: Aug. 17, 2015

Related U.S. Application Data
(60) Provisional application No. 62/186,529, filed on Jun. 30, 2015.

(51) Int. Cl. G06F 3/01; G06F 3/00; G06F 3/03; G06K 9/00

(52) U.S. Cl. CPC G06F 3/017; G06K 9/00335; G06F 3/005; G06F 3/0325

(57) ABSTRACT

Apparatus performs a method for automatically operating a gesture control system for a projection system. The method includes determining a location of an object relative to the gesture control system for the projection system. The method further includes automatically operating the gesture control system based on the determined location of the object.

### RELATED APPLICATION

The present application is related to and claims benefit under 35 U.S.C. §119(e) of the U.S. Provisional Patent Application Ser. No. 62/186,529, filed Jun. 30, 2015, titled “Method and Apparatus for Automatically Operating a Gesture Control System for a Projection System” (attorney docket no. MM01101), which is commonly owned with this application by Motorola Mobility LLC, and the entire content of which is incorporated herein by reference.

### FIELD OF THE DISCLOSURE

The present disclosure relates generally to gesture control systems and more specifically to a method and apparatus for automatically operating a gesture control system for a projection system.

### BACKGROUND

Today's electronic devices are often sized for increased mobility. As a result, many of these devices fit readily into a purse or pocket. These types of electronic devices are often referred to as mobile devices. However, mobile devices can have small display screens. Therefore, in some situations, the display screen size limits the user experience. Hence, there is a desire to enlarge the screen by projecting images from the mobile device, and allow for greater user interaction with the projected images.

In order to enable a full user interaction experience, a camera (also referred to herein interchangeably as an imager) associated with the mobile device, is activated to read specific movements from the user. The user's movements are also referred to as gestures. Visual clarity of the projected images can be improved by using a separate light source to eliminate negative effects of ambient light. However, camera usage and a separate illumination source have a high power consumption.

### BRIEF DESCRIPTION OF THE FIGURES

The accompanying figures, where like reference numerals refer to identical or functionally similar elements throughout the separate views, form part of the specification and illustrate embodiments in accordance with the included claims.

FIG. 1 illustrates a schematic diagram of a mobile device that incorporates an automatically operated gesture control system for a projection system, in accordance with some embodiments.

FIG. 2 shows a flow diagram illustrating a method for automatically operating a gesture control system for a projection system, in accordance with some embodiments.

FIG. 3 shows a block diagram of internal components of an electronic system configured with an automatically operated gesture control system for a projection system, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present teachings. In addition, the description and drawings do not necessarily require the order presented. It will be further appreciated that certain actions and/or steps may be described or depicted in a particular order of occurrence while those skilled in the art will understand that such specificity with respect to sequence is not actually required.

The apparatus and method components have been represented, where appropriate, by conventional symbols in the drawings, showing only those specific details that are pertinent to understanding the embodiments of the present teachings so as not to obscure the disclosure with details that will be readily apparent to those of ordinary skill in the art having the benefit of the description herein.

### DETAILED DESCRIPTION

Generally speaking, pursuant to various embodiments described herein, the present disclosure provides a method and apparatus for automatically operating a gesture control system for a projection system. In this regard, the method includes determining a location of an object relative to the gesture control system for the projection system and automatically operating the gesture control system based on the determined location of the object.

Additionally, an electronic system is configured with an automatically operated gesture control system for a projection system. The electronic system includes a projection system, a gesture control system, a set of sensors, and a processor that are operatively coupled. The projection system is configured to generate a projected image, and the gesture control system is configured to detect input gestures for interacting with the projected image. The set of sensors is configured to detect a location of an object and provide location data. The processor is configured to receive the location data and determine the location of the object relative to the gesture control system. The processor is further configured to automatically activate the gesture control system when the object is within a defined proximity of the gesture control system and automatically deactivate the gesture control system when the object is outside the defined proximity of the gesture control system.

Automatically operating the gesture control system can provide power saving benefits by operating high battery drain components only when needed. Additionally, the user experience is enhanced by automating the on and off switching of the gesture control system. Such are illustrative benefits that can be realized by the present teachings.

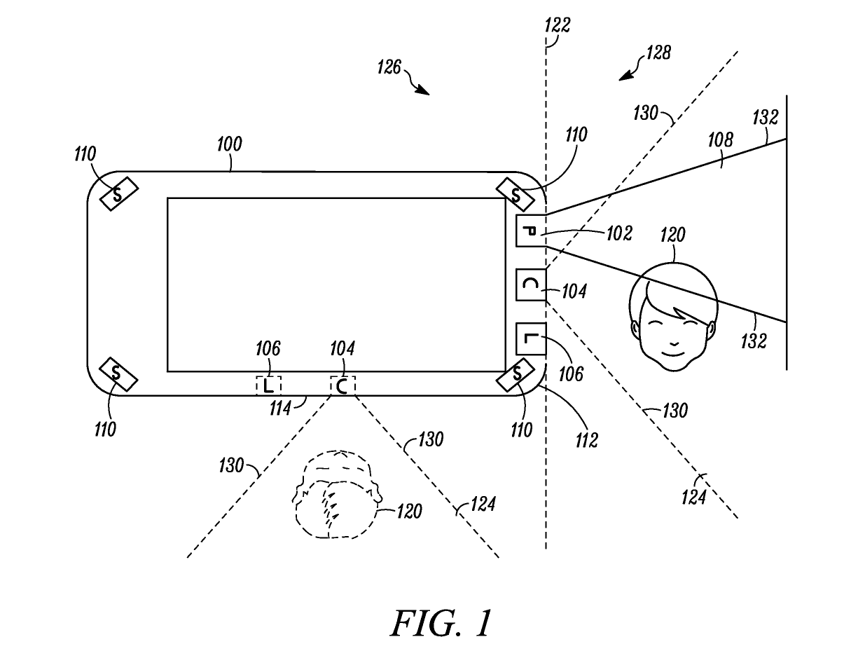

FIG. 1 shows an electronic device 100 that incorporates an automatically operated gesture control system for a projection system, in accordance with some embodiments. As shown the electronic device 100 is a mobile device. Example mobile devices include a smartphone, a cellular phone, a phablet, a tablet, a gaming device, a personal digital assistant, a mobile phone, a media player, a laptop, or other types of portable electronic devices capable of automatically operating a gesture control system for a projection system, in accordance with various implementation scenarios of the disclosed embodiments. “Automatically operating,” as used herein, means that the operating is not as a direct result of user tactile or other directed or managed input. For example, the user is not directly managing the turning or switching on and off of the gesture control system, for instance by changing a setting of the electronic device 100.

As shown, the electronic device 100 includes: a projection system or projector 102 configured to project an image; a gesture control system, which includes an imager or camera 104 and a lighting source 106, configured to detect input gestures, or motions or movements, for interacting with the projected image; and a set of sensors 110 configured to detect location of an object, such as a user 120 or a part of the user's body, and provide resultant location data. The projector 102 projects images within an area of projection, indicated at 108, bounded by lines 132. The sensors 110 are located at the four corners of the electronic device 100, but could in other embodiments be located in other areas of the device 100 such as a front or backside of the device 100.

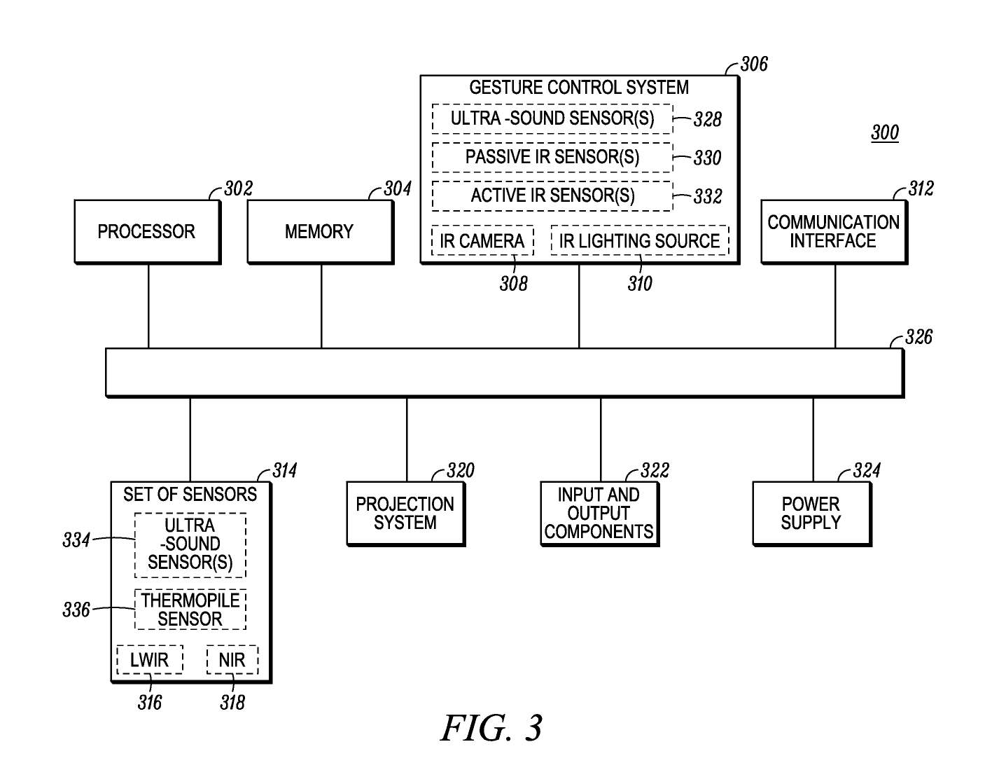

Additionally, in the illustrated embodiment, as indicated by solid lines, the projection system 102 and gesture control system 104, 106 are located on a same side 112 of the electronic device 100. However, in an alternate embodiment, as indicated by dashed lines, the projection system 102 and gesture control system 104, 106 are located on different sides 112 and 114, respectively, of the electronic device 100. Details of example projectors 102, gesture control systems, and sensors 110 that can be implemented in an electronic system 100, other components of the system 100 (not shown), and other electronic system example implementations and their operation, are described below by reference to FIG. 3.

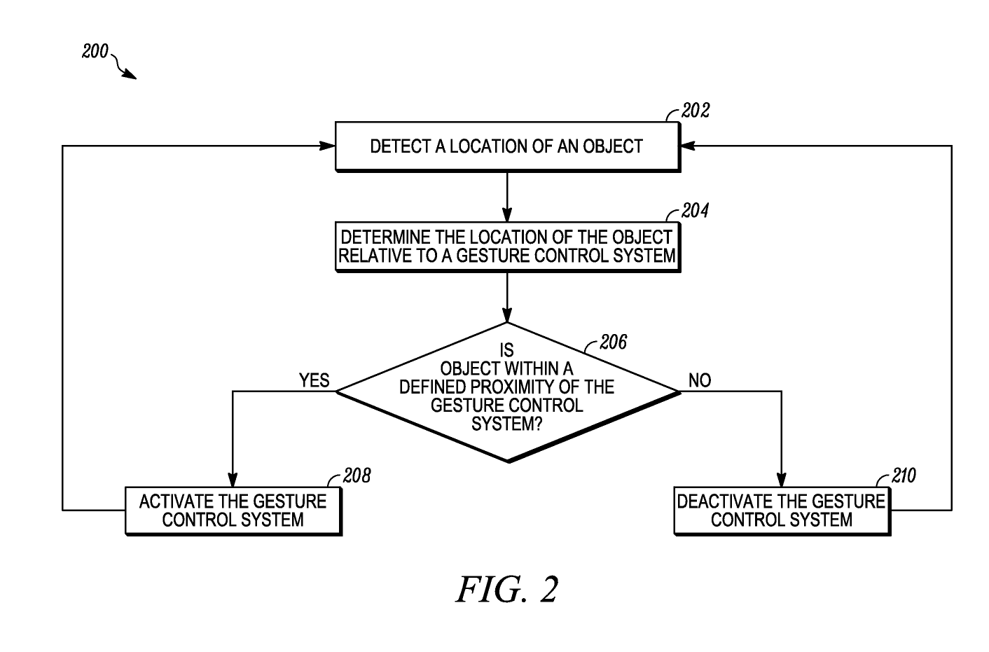

FIG. 2 shows a flow diagram illustrating a method 200 for automatically operating a gesture control system for a projection system, in accordance with some embodiments. The method 200 can be performed in an electronic system such as the electronic device 100 of FIG. 1. The method 200 includes the electronic device 100, for instance using one or more of the sensors 110, detecting 202 a location of an object, such as the user 120 or a device, such as some type of accessory, on the user's person. For some embodiments, the location of the object is detected using at least one of a set of thermal sensors, a set of near-infrared proximity sensors, a set of passive infrared sensors, or a set of ultrasound sensors. Details of these types of sensors, including their operation, are described below by reference to FIG. 3.

The electronic device 100 then determines 204 the location of the object, e.g., the user 120, relative to the gesture control system 104, 106. For one embodiment, the sensors 110 detect the location of the user 120 and generate location data indicating the user's location relative to the electronic device 100. The location data can indicate a spatial location, for instance using position vectors or other data that can be converted to position vectors, which the sensors 110 provide to a processor (not shown in FIG. 1) in the electronic device 100.

The electronic device 100 can also include sensors such as a gyroscope and/or accelerometer (not shown in FIG. 1) that can be used to detect and provide position data, e.g., position vectors, indicating the location and/or orientation of the electronic device 100. Moreover, for an embodiment, position vectors indicating the location of the gesture control system 104, 106 and one or more defined proximity areas relative to the gesture control system 104, 106 can be stored in a memory element or component (not shown in FIG. 1), which is accessible to the processor.

Accordingly, the processor can use: the position vectors indicating the position of the user 120 relative to the electronic device 100; and/or the position vectors indicating the location and/or orientation of the electronic device 100; and/or the position vectors indicating one or more defined proximity areas relative to the gesture control system 104, 106 to determine 204 the location of the user 120 relative to the gesture control system 104, 106. For example, the processor determining the location of the user 120 relative to the gesture control system 104, 106 includes the processor determining 206 whether the user 120 is within a defined proximity of the gesture control system 104, 106. Based on the result of decision 206, the processor can automatically operate the gesture control system 104, 106 by activating 208 or deactivating the 210 the gesture control system 104, 106. Namely, the processor activates 208 the gesture control system 104, 106 when the user 120 is detected within the defined proximity of the gesture control system 104, 106. Further, the processor deactivates 210 the gesture control system 104, 106 when the user 120 is detected outside the defined proximity of the gesture control system 104, 106.

A “defined proximity” is an area having boundaries that define a trigger for automatically operating the gesture control system. The trigger could include, for instance, prioritizing when the imager 104 and the lighting source 106 turn on relative to other operating functions of the electronic device 100 that normally have a higher functional priority. FIG. 1 illustrates some example defined proximity areas indicated at 108, 124, and 128. The larger the proximity area, the sooner the gesture control system is triggered to operate, with a correspondingly longer time of operation and greater battery drain. By contrast, for a smaller proximity area, the gesture control system is triggered to operate at a comparatively later time with a shorted operation time and less battery drain. Thus, a balancing of responsiveness to a user and battery drain is performed in selecting a size of the proximity area. Nonetheless, even the larger proximity areas enable power savings over always leaving the gesture control system 104, 106 operating.

For one example, the proximity area is defined relative to a particular side of the electronic device 100. For instance, the proximity area 128 is defined relative to the side 112 of the electronic device 100 on which the gesture control system 104, 106 is located. For this example, determining 204 the location of the user 120 relative to the gesture control system 104, 106 includes determining when the user 120 moves to the side 112 of the electronic device on which the gesture control system 104, 106 is located. Accordingly, the electronic device 100 activates 208 the gesture control system 104, 106 upon determining 206 that the user 120 is within the area 128 to the right side of a dashed line 122 (as shown). The electronic device 100 deactivates 210 the gesture control system 104, 106 upon determining 206 that the user 120 is outside the area 128 and inside an area 126 to the left side of the dashed line 122.

For another example, a smaller proximity area 124 is defined relative to a “field of view” of the gesture control system. The field of view is an area within which an object, e.g., the user 120, can be detected or sensed by the gesture control system and, thereby, can depend at least in part on the particular implementation of the gesture control system. For the gesture control system embodiment shown in FIG. 1, the imager 104 detects the user 120 or movements of the user 120. Thus, the field of view of the gesture control system includes (and in this case is) the field of view 124 of the imager 104, bounded by dashed lines 130. Where other types of detecting or sensing components are used in the gesture control system, the field of view is correspondingly defined by the area or areas within which the sensing component can actually “view” or sense the user 120.

For this example, determining 204 the location of the user 120 relative to the gesture control system 104, 106 includes determining the location of the user 120 relative to the field-of-view of the gesture control system and more particularly relative to the field-of-view of the imager 104 of the gesture control system. Accordingly, the electronic device 100 activates 208 the gesture control system 104, 106 upon determining 206 that the user 120 is within the area 124 (as shown). The electronic device 100 deactivates 210 the gesture control system 104, 106 upon determining 206 that the user 120 is outside the area 124.

Where, for instance, the gesture control system 104, 106 is on the same side, e.g., 112, of the electronic device 100, the defined proximity area (in this case the field of view 124) can at least partially overlap the area 108 within which an image is projected. Thus, for yet another example, the proximity area for triggering the operation of the gesture control system 104, 106 could include or be otherwise based on the overlap area of the areas 108 and 124. Accordingly, for at least this embodiment, detecting the location of the user 120 relative to a projected image within at least some portion of area 108 enables controlling power usage of either the imager 104 or the lighting source 106 or both.

For the embodiment of the electronic device 100 shown in FIG. 1, activating and deactivating the gesture control system can include controlling one or both of the imager 104 and the lighting source 106 to turn on and off. Controlling both components to turn on and off would likely generate the most power savings. However, where for instance one or the other component drains more power or one or the other component takes a significantly longer time to turn on, the electronic device 100 might, using the present teachings, adaptively control the component that drains more power or that takes the shorter amount of time to turn on. Correspondingly, during the time the electronic device 100 is on and/or when the electronic device 100 is in an awake state, the electronic device 100 could leave on the other component that draws less power or that take a longer time to turn on.

For another embodiment, activating and deactivating the gesture control system 104, 106 includes, respectively, coupling and decoupling an internal power supply source (not shown in FIG. 1) to one or more components of the gesture control system 104, 106. In any case, power utilized by the electronic device 100 is reduced using the illustrative method 200 because a high power consuming imager 104 and lighting source 106 can be automatically turned off when the user 120 is not within a defined proximity of the gesture control system.

FIG. 3 shows a block diagram of internal components of an electronic system 300 configured with an automatically operated gesture control system for a projection system, in accordance with some embodiments. The electronic system 300 includes one or more processors 302 (although the processor 302 is often referred to herein in the singular), a data storage or memory element 304, a gesture control system 306, a communication interface 312, a set of sensors 314, a projection system 320, input and output components 322, and a power supply 324. All heretofore described components are operationally and communicatively coupled by wireless or wired couplings 326 some of which are internal couplings, such as an internal bus.

The electronic system 300 can represent any type of system that includes a gesture control system, a projection system, and a set of sensors, examples of which are described above by reference to device 100 of FIG. 1. However, all components needed to implement the present teachings need not reside or be integrated within a single electronic device as shown in FIG. 1. The components can be distributed across multiple devices (not shown). For one embodiment, the projection system 320, gesture control system 306, and set of sensors 314 for location detection are instead all integrated within an external module. The external module electronically and/or physically couples to an electronic device, for instance using a wired connection such as Universal Serial Bus connection or a wireless connection such as Bluetooth connection. Such a module could be implemented as an external accessory or protective case.

For another embodiment, the projection system 320, gesture control system 306, and set of sensors 314 are partially integrated within the electronic device and partially integrated within the external module. For one example, the projection system 320 is incorporated with the gesture control system 306 within a larger-scale interactive projector or within a protective case, which can be electronically coupled to an electronic device that includes the set of sensors 314. For another example, only the projection system 320 is included within the separate module, and the remaining components reside within the electronic device. Other examples can be imagined.

A limited number of system components 302, 304, 306, 312, 314, 320, 322, 324, and 326 are shown at 300 for ease of illustration. Other embodiments may include a lesser or greater number of components in an electronic system. Moreover, other components needed for a commercial embodiment of an electronic system that incorporates the components 302, 304, 306, 312, 314, 320, 322, 324, and 326 shown at 300 are omitted from FIG. 3 for clarity in describing the enclosed embodiments.

In general, the electronic system 300 is configured with functionality in accordance with embodiments of the present disclosure as described herein with respect to the other figures. “Configured,” “adapted,” “operative,” or “capable,” as used herein, means that indicated system and components are implemented using one or more hardware elements, such as one or more operatively coupled processors, e.g., 302, and sensors, e.g., 314, which may or may not be programmed with software and/or firmware, as the means for the indicated components to implement their desired functionality. Such functionality is supported by the other hardware shown in FIG. 3, including the system components 304, 306, 312, 320, 322, and 324, which are all operatively coupled by the component 326.

The processor 302, for instance, includes arithmetic logic and control circuitry necessary to perform the digital processing, in whole or in part, for the electronic system 300 to automatically operate a gesture control system for a projection system in accordance with described embodiments for the present teachings. For one embodiment, the processor 302 represents a primary microprocessor, also referred to as a central processing unit (CPU), of the electronic system 300. For example, the processor 302 represents an application processor (AP) of the electronic system 300. In another embodiment, the processor 302 is an ancillary processor such as a secondary low-power processor, separate from the CPU, which is dedicated to providing the processing capability, in whole or in part, needed for the components of the electronic device 300 to perform at least some of their intended functionality, for instance as shown in FIG. 2. For a particular embodiment, the ancillary processor is included with the sensors 314 in a sensor hub.

The memory 304 provides storage of electronic data used by the processor 302 in performing its functionality. For example, the processor 302 uses the memory 304 to store files associated with analyzing and acting on location data received from the sensors 314, for mobile applications, and for controlling power operations of the electronic system 300. In one embodiment, the memory 304 represents random access memory (RAM). In other embodiments, the memory 304 represents volatile or non-volatile memory.

The gesture control system 306 enables detecting motions and movements of a user 120 as the user interacts with the electronic system 300, for instance as the user interacts with images projected from the projection system 320. The gesture control system 306 is automatically activated and deactivated, e.g., turned on and off, based on a location of an object such as the user. For instance, the processor 302 directly (or indirectly through some additional hardware not shown) activates and deactivates the gesture control system 306.

Gestures, motions, movements, and interactions are referred to herein interchangeably. However, a gesture can be considered a particular movement that conveys a corresponding command to the gesture control system 306. The user's interactions include, but are not limited to, cursor or pointer control, zooming and enlarging portions of the projected images, and overlaying or fusing one image upon another image. Example uses of the gesture control system 306 are gaming control, music selection, and presentation control such as controlling presentation slides.

One or more components of the gesture control system 306 detect or sense, and may also capture or enhance, the user's movements, including for instance head, hand, arm, torso, and leg movements, as well as overall body movements. For one embodiment, the gesture control system 306 includes an imager, for instance a camera, to detect or sense the user's movements. The camera or imager is configured to capture images at a designated resolution. In one embodiment, the resolution is rated as high-definition (HD) based on the amount of image data captured by the imaging sensor. Example imagers include a conventional charge-coupled device (CCD) or complementary metal oxide sensor (CMOS).

The gesture control system 306 may also include a lighting source to illuminate an area where a user of the electronic system 300 is gesturing or otherwise interacting with the system 300. For example, the lighting source emits light upon the user, thereby illuminating the user's actions and movements, while also offsetting any ambient light that happens to fall upon the user. One example lighting source is an infrared light emitted diode (LED).

An example imager and lighting source combination operates using infrared (IR) technology, such as a near infrared (NIR) camera 308, which can detect and/or sense movements up to a few meters, and an IR lighting source 310. The gesture control system 306 could alternatively be implemented using at least one active IR sensor 332 that includes a receiver, e.g., a diode, to sense or detect user movement and an LED as the lighting source. Another implementation for the gesture control system 306 includes a set of passive IR sensors 330 such as thermopile sensors. In this implementation, a user's movements are sensed by detecting location of the user's body heat “transmissions.” A benefit of these thermal sensors is a longer sensing or detection range than the other implementations, since the body acts as a very large heat source. For yet another implementation, the gesture control system 306 includes a set of ultrasound sensors 328 that sense or detect the user's movements by detecting echoes of radio or sound waves from the user's body.

The communication interface 312 allows for communication between the electronic system 300 and other devices, such as mobile devices, servers, or infrastructure devices. For one embodiment, the communication interface 312 includes a cellular transceiver to enable the electronic system 300 to wirelessly communicate with other electronic devices using one or more cellular networks. Cellular networks can use any wireless technology that, for example, enables broadband and Internet Protocol (IP) communications including, but not limited to, 3^{rd} Generation (3G) wireless networks such as CDMA2000 and Universal Mobile Telecommunications System (UMTS) networks or 4^{th} Generation (4G) wireless networks such as Long-Term Evolution (LTE) and WiMAX networks.

In another embodiment, the communication interface 312 includes a wireless local area network (WLAN) transceiver that allows the electronic system 300 to access the Internet using standard protocols, for instance. The WLAN transceiver allows the electronic system 300 to send and receive radio signals to and from similarly equipped electronic devices using a wireless distribution method, such as a spread-spectrum or orthogonal frequency-division multiplexing (OFDM) method. For some embodiments, the WLAN transceiver uses an IEEE 802.11 standard to communicate with other electronic devices in the 2.4, 3.6, 5, and 60 GHz frequency bands. In a particular embodiment, the WLAN transceiver uses Wi-Fi interoperability standards as specified by the Wi-Fi Alliance to communicate with other Wi-Fi certified devices.

For additional embodiments, the communication interface 312 uses hard-wired, rather than wireless, connections to a network infrastructure that allows the electronic system 300 to communicate electronically with other devices. For example, the communication interface 312 includes a socket that accepts an RJ45 modular connector that allows the electronic system 300 to be connected directly to a network router by category-5 or category-6 Ethernet patch cable. The communication interface 312 can also use a cable modem or a digital subscriber line (DSL) to connect with other electronic devices through the Internet via an Internet service provider (ISP).

The set of sensors 314 are configured to detect location of an object, such as a user of the electronic system 300 or part of the user's body, and provide location data to the processor 302 that indicates the position of the object, for instance location data that indicates the position of the user relative to the electronic system 300. Different types of sensors alone or in combination can be included within the set of sensors 314 for location detection. Moreover, in at least one embodiment, the set of sensors 314 is positioned around the periphery or perimeter of the electronic system 300. For a particular embodiment, illustrated by reference to the electronic device 100 shown in FIG. 1, the sensors 314 are positioned at the four corners of the electronic system 300. However, the sensors 314 can be located in other areas around the periphery of the electronic system 300 or in other areas such as the front or back of the system 300.

Examples of types of sensors include some of the types of sensors that can be used to implement the gesture control system 306, including ultrasound sensors 334 and passive IR sensors such as thermopile sensors 336. For another embodiment, the set of sensors 314 is implemented using one or more thermal sensors such as one or more long wave infrared (LWIR) sensors 316. Since the LWIR sensor detects user location using body heat, the sensors 316 could accurately detect a living body up to tens of meters. When coupled to a thermal camera (not shown), a heat or thermal map may be generated and used to identify a specific person out of a group of people.

For another embodiment, the set of sensors 314 includes a set of NIR proximity sensors 318. In some implementations, the NIR sensor 318 is a very high power proximity sensor that uses IR technology capable of detecting or sensing location at a distance of a few meters, for example. Accordingly, the NIR sensors 318 provides for greater accuracy than the LWIR sensors 316. However, the NIR sensors 318 would require significantly more power to sense at the same range as the LWIR sensors 316. Additionally, the NIR sensors 318 are configured to detect a moving object but not the type of object, such as whether the moving object is a human. Nonetheless, given certain contexts and locations, an application within the electronic system 300 can intelligently or logically infer that a moving object would likely be a person, especially when coupled with other sensor technology such as audio sensors to aid in voice recognition.

As indicated above, the set of sensors 314 can also include sensors, such as an accelerometer or gyroscope (not shown), which can detect location and/orientation of the electronic system 300. Additionally, the set of sensors 314 can include sensors that utilize Bluetooth or other short-range wireless technology to detect or sense the user by detecting or sensing objects on the user's person.

The projection system 320 is configured to generate a projected image. For one embodiment, the projection system 320 is an optical device that creates an image by shining a light through a small transparent lens or directly using lasers. For a particular embodiment, the projection system 320 utilizes a handheld or micro projector (also known as a pocket projector, mobile projector, pico projector, or mini beamer) technology that incorporates an image projector into a handheld device. Example, technologies for micro projectors include, but are not limited to, digital light processing (DLP), beam-steering, and liquid crystal on silicon (LCOS) that can be combined with color sequential (red, green, blue) LEDs. In other embodiments, the projection system 320 is included in a separate module or as a projector having a larger form factor than the micro projectors.

The input and output components 322 represents user-interface components of the electronic system 300, which are configured to allow a person to use, program, or otherwise interact with the electronic system 300. For brevity sake, input components and output components are illustrated as combined input/output components 322. Different electronic systems for different embodiments include different combinations of input/output components 322. In some implementations, the input/output components 322 are separate and distinct, while in other implementations the input/output components 322 have combined functionality. A touchscreen, for example, functions both as an output component and an input component for some embodiments by allowing a user to see displayed view elements for a mobile application and to actuate the view elements by tapping on them.

Peripheral devices, for other embodiments, such as keyboards, mice, and touchpads, represent input components 322 that enable a user to interact with the electronic system 300. A speaker is an example output component 322 that allows an electronic system 300 to emit acoustic signals, such as voice, ringtones, music, and beeps, for example, via an acoustic transducer, which converts electronic signals into acoustic signals.

The power supply 324 represents a power source that supplies electrical power to the system components 302, 304, 306, 312, 314, 320, 322 and 326 as needed, during the course of their normal operation. The power is supplied to meet the individual voltage and load requirements of the system components 302, 304, 306, 312, 314, 320, 322 and 326 that draw electric current. For some embodiments, the power supply 324 is a wired power supply that provides direct current from alternating current using a full- or half-wave rectifier. For other embodiments, the power supply 324 is a battery that powers up and runs a mobile device. For a particular embodiment, the battery 324 is a rechargeable power source. A rechargeable power source for a device is configured to be temporarily connected to another power source external to the device to restore a charge of the rechargeable power source when it is depleted or less than fully charged. In another embodiment, the battery is simply replaced when it no longer holds sufficient electrical charge or voltage.

The system interconnections 326 communicatively couple the various system components 302, 304, 306, 312, 314, 320, 322, and 324 together. Accordingly, the system components 302, 304, 306, 312, 314, 320, 322, and 324 can communicate data and signals via the component 326 to effect operation of the electronic system 300. Other system components that are not shown may also interact with the interconnections 326 for similar operation of the electronic system 300. In other embodiments, other direct and indirect physical connections are configured to couple the various system components together in order to provide operational functionality to the electronic system 300.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like are used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but also includes other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but are just as likely to be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for automatically operating a gesture control system for a projection system, the method comprising:
determining a location of an object relative to a gesture control system for a projection system;
automatically operating the gesture control system based on the determined location of the object.

2. The method of claim 1, wherein determining the location of the object relative to the gesture control system comprises determining the location of the object relative to a field-of-view of the gesture control system.

3. The method of claim 2, wherein determining the location of the object relative to the field-of-view of the gesture control system comprises determining the location of the object relative to a field-of-view of an imager of the gesture control system.

4. The method of claim 1, wherein determining the location of the object relative to the gesture control system comprises determining when the object moves to a side of an electronic device on which the gesture control system is located.

5. The method of claim 1, wherein determining the location of the object relative to the gesture control system comprises determining whether the object is within a defined proximity of the gesture control system.

6. The method of claim 5, wherein the defined proximity of the gesture control system at least partially overlaps an area within which an image is projected.

7. The method of claim 5, wherein automatically operating the gesture control system based on the determined location of the object comprises:
activating the gesture control system when the object is detected within the defined proximity of the gesture control system;
deactivating the gesture control system when the object is detected outside the defined proximity of the gesture control system.

8. The method of claim 7, wherein activating and deactivating the gesture control system comprises controlling an imager to turn on and off.

9. The method of claim 8, wherein activating and deactivating the gesture control system further comprises controlling a lighting source to turn on and off.

10. The method of claim 1, wherein determining the location of the object relative to the gesture control system comprises determining the location of the object using at least one of a set of thermal sensors, a set of near-infrared proximity sensors, a set of passive infrared sensors, or a set of ultrasound sensors.

11. An electronic system configured with an automatically operated gesture control system for a projection system, the electronic system comprising:
a projection system configured to generate a projected image;
a gesture control system configured to detect input gestures for interacting with the projected image;
a set of sensors configured to detect a location of an object and provide location data;
a processor coupled to the projection system, gesture control system, and set of sensors, wherein the processor is configured to:
receive the location data;
determine the location of the object relative to the gesture control system;
automatically activate the gesture control system when the location of the object is within a defined proximity of the gesture control system;
automatically deactivate the gesture control system when the location of the object is outside the defined proximity of the gesture control system.

12. The electronic system of claim 11, wherein the gesture control system comprises an imager.

13. The electronic system of claim 12, wherein the gesture control system further comprises a lighting source.

14. The electronic system of claim 13, wherein the imager and lighting source operate using infrared technology.

15. The electronic system of claim 11, wherein the gesture control system comprises at least one of:
an active infrared system having a light emitting diode and a receiver;
a set of passive infrared sensors; or
a set of ultrasound sensors.

16. The electronic system of claim 11 wherein the projection system, gesture control system, and set of sensors are one of:
all integrated within an electronic device;
all integrated within an external module that couples to the electronic device; or
partially integrated within the electronic device and partially integrated within the external module.

17. The electronic system of claim 16, wherein the set of sensors configured to detect the location of an object and provide location data comprises at least one of:
a set of thermal sensors;
a set of near-infrared proximity sensors;
a set of passive infrared sensors; or
a set of ultra-sound sensors.

18. The electronic system of claim 17, wherein the set of thermal sensors comprises a set of long-wavelength infrared sensors.

19. The electronic system of claim 11, wherein the projection system and gesture control system are on a same side of an electronic device.

20. The electronic system of claim 11, wherein the projection system and gesture control system are on a different side of an electronic device.
